(19) United States
(12) Patent Application Publication
(10) Pub. No.: US 2018/0057156 A1
(43) Pub. Date: Mar. 1, 2018

(54) AIRCRAFT PROVIDED WITH A SET OF SWASHPLATES AND WITH AT LEAST ONE SERVO-CONTROL THAT IS INCLINED

(71) Applicant: AIRBUS HELICOPTERS, Marignane (FR)

(72) Inventor: Alain STRUZIK, Aix En Provence (FR)

(73) Assignee: AIRBUS HELICOPTERS, Marignane (FR)

(21) Appl. No.: 15/690,348

(22) Filed: Aug. 30, 2017

(30) Foreign Application Priority Data
Aug. 31, 2016 (FR) 1601282

(51) Int. Cl. B64C 27/605

(52) U.S. Cl. CPC B64C 27/605

(57) ABSTRACT

An aircraft provided with a rotor that is provided with blades and a set of swashplates. The set of swashplates comprises both a rotary swashplate and also a non-rotary swashplate, a lower scissors linkage being hinged to the non-rotary swashplate and being hinged to a member that is stationary in rotation about the axis of rotation, the rotor comprising a plurality of servo-controls each provided with a top hinge hinged to a top attachment fitting of the non-rotary swashplate and with a bottom hinge hinged to a bottom attachment fitting that is stationary in a reference frame of the aircraft. For at least one servo-control referred to as the “inclined servo-control”, the bottom hinge is offset in azimuth about the axis of rotation relative to the top hinge.

### CROSS-REFERENCE TO RELATED APPLICATIONS

This application claims priority to French patent application No. FR 16 01282 filed on Aug. 31, 2016, the disclosure of which is incorporated in its entirety by reference herein.

### BACKGROUND OF THE INVENTION

### (1) Field of the Invention

The present invention relates to an aircraft provided with a set of swashplates and with at least one servo-control that is inclined.

### (2) Description of Related Art

In particular, the aircraft is provided with a rotary wing. This rotary wing comprises a main rotor contributing to lift and even to propulsion of the aircraft. Conventionally, such a main rotor comprises a rotor mast that sets a plurality of blades into rotation, possibly by means of a rotor hub.

In order to control movement of the aircraft, the pitch of the blades of the main rotor is controlled.

Cyclic variation in the pitch of the blades of a rotor makes it possible to vary the pitch of each blade as a function of its azimuth. However, collective variation of pitch of the blades of a rotor leads to identical variation in the pitch of all of the blades of the rotor.

By way of example, a main rotor of the helicopter makes it possible to ensure both:

cyclic variation in the pitch of the blades of the main rotor so as to vary pitch angle as a function of the azimuth of the blades;

collective variation of the pitch of all of the blades of the main rotor.

Under such circumstances, the pitch of the blades of a rotor may be adjustable by means of pitch control rods and of a set of swashplates arranged around the rotor mast.

In principle, the set of swashplates is provided with a rotary swashplate connected to the pitch control rods, and with a non-rotary swashplate connected to the flight controls.

The non-rotary swashplate is situated under the rotary swashplate, or is for example surrounded by the rotary swashplate. In addition, the non-rotary swashplate is connected to the rotary swashplate in order to impart its movements to the rotary swashplate. Thus, the rotary swashplate follows all the movements of the non-rotary swashplate and transmits those movements to the blades via pitch control rods.

Consequently, the non-rotary swashplate and the rotary swashplate are suitable both for being moved in translation along the rotor mast, and also for being inclined relative to the rotor mast. The non-rotary swashplate and the rotary swashplate may be moved in translation and their angle of inclination may be varied by means of a device that comprises a mast ball-joint centered on the axis of rotation of the rotor and that slides, e.g. along a structural element. By way of example, this structural element is stationary in the reference frame of the aircraft and constitutes a local guide around the rotor mast.

The non-rotary swashplate is thus arranged to oscillate on the mast ball-joint in such a manner as to be capable of being inclined and moved in translation relative to the rotor mast.

The rotary swashplate of the set of swashplates is thus connected to the non-rotary swashplate by a connection member enabling:

the rotary swashplate to be secured to the non-rotary swashplate in translation along the rotor mast;

the rotary swashplate to oscillate around the mast ball-joint jointly with the non-rotary swashplate; and

the rotary swashplate to rotate about the axis of rotation of the rotor jointly with the blades.

In order to move the set of swashplates in translation along the rotor mast and/or in rotation about the mast ball-joint, the aircraft includes at least three servo-controls hinged to the rotary swashplate.

When all the servo-controls extend or retract in the same manner, the set of swashplates moves in translation in order to modify collectively the pitch of the blades of the rotor. However, when at least one servo-control is acts in a way that is different from other servo-controls, the set of swashplates is inclined in order to modify the cyclic pitch of the blades of the rotor.

The servo-controls extend in elevation from a bottom hinge fastened to a bottom attachment fitting that is stationary in the reference frame of the aircraft, towards a top hinge fastened to a top attachment fitting of the non-rotary swashplate. The bottom and top hinges of a servo-control are in the same azimuth position relative to the axis of rotation of the rotor.

The bottom and top hinges of a servo-control are optionally spaced apart radially from the axis of rotation by respective top and bottom radii that are different. The servo-controls are contained substantially in a cone.

In addition, the rotary swashplate is driven in rotation by the rotor mast through at least one rotary scissors linkage. To this end, the rotary swashplate is attached to at least one rotary scissors linkage connected to the rotor mast, possibly by the hub of the main rotor. The rotor mast thus drives the rotary swashplate directly or indirectly in rotation about the axis of rotation.

Conversely, the non-rotary swashplate is fastened to the structure of the rotorcraft, possibly to a main gearbox, by means of at least one stationary scissors linkage that tends to prevent it from rotating about the axis of rotation of the rotor.

A scissors linkage, whether rotary or non-rotary, may comprise two branches that are hinged together. More precisely, a scissors linkage may comprise a top branch and a bottom branch hinged together by a central hinge. The central hinge enables the two branches of a scissors linkage to move apart from or towards each other in order to allow movement in translation or in rotation of the swashplate connected to the scissors linkage.

The non-rotary scissors linkage is thus provided with a top branch hinged to the non-rotary swashplate via a top hinge that is sometimes of the ball-joint type. In addition, the non-rotary scissors linkage is provided with a bottom branch hinged by way of example to a casing of a main gearbox via a bottom hinge.

The bottom hinge and the central hinge are sometimes pivot hinges, each presenting an axial clearance of up to one millimeter. Consequently, the total axial clearance of the non-rotary scissors linkage may reach two millimeters.

When the rotary scissors linkage is subjected to two types of torque, the total axial clearance confers to the non-rotary swashplate a degree of freedom that is limited in rotation about the axis of rotation of the rotor. The non-rotary swashplate is conventionally considered as being stationary in rotation about the axis of rotation of the rotor, ignoring axial clearances of the non-rotary scissors linkage.

In particular, the non-rotary scissors linkage is subjected to a first torque induced by the friction of a bearing device situated between the rotary swashplate and the non-rotary swashplate. That friction tends to generate the beginning of rotation of the non-rotary swashplate. Rotation of the non-rotary swashplate is stopped specifically by the non-rotary scissors linkage when the total axial clearance is taken up. For a ball bearing device, the torque resulting from friction of the bearing device is due to friction of the balls in their tracks. The torque resulting from the friction of the bearing device is always directed in the direction of rotation of the rotor mast, but its value varies over time.

In addition, the non-rotary scissors linkage is subjected to second torque induced by the servo-controls when the set of swashplates is tilted. The forces introduced by the servo-controls in order to tilt the set of swashplates have tangential components tending to move the non-rotary swashplate in rotation. Those tangential components are at the origin of the second torque exerted on the non-rotary scissors linkage.

The intensity of each torque varies during each revolution during rotation of the rotor as a function of the maneuver being performed by the aircraft, of the weight and of the center of gravity of the aircraft, and also of certain environmental parameters such as altitude and outside temperature, for example.

In particular, the second torque induced by the servo-controls may change sign several times during a revolution performed by a rotor, e.g. by taking a value in the range −50 newton meters (Nm) to +200 Nm. The change in sign of the second torque induced by the servo-controls may thus generate axial shocks to which the non-rotary scissors linkage is subjected.

The non-rotary scissors linkage is subjected to shocks when the second torque induced by the servo-controls changes sign during a revolution performed by the rotor, and, when at the same time the first torque resulting from the friction of the bearing device is less than the second torque induced by the servo-controls during a revolution performed by the rotor.

Such a situation may in particular occur in downward flight of the aircraft or also during level flight when a turn is performed at high speed.

These shocks are represented by very considerable peaks of force exerted in the hinges of the non-rotary scissors linkage, e.g. forces lying in the range −500 newtons (N) to +1000 N.

Although strong, under such conditions, the hinges of a scissors linkage and in particular of the non-rotary scissors linkage are subjected to wear that implies expensive and recurrent maintenance actions.

To correct that, the scissors linkages are often overdimensioned, and therefore end up being heavy and expensive to manufacture.

Documents EP 1 954 559, FR 2 951 699, and FR 2 768 996 describe various sets of swashplates.

Documents FR 2 579 170 and WO 2009/153236 are also known.

### BRIEF SUMMARY OF THE INVENTION

An object of the present invention is thus to propose an aircraft tending to optimize the torque to which the non-rotary scissors linkage is subjected, potentially to be able to envisage using a less expensive non-rotary scissors linkage.

According to the invention, an aircraft is provided with a rotor, the rotor being provided with blades and a set of swashplates, the set of swashplates comprising both a rotary swashplate connected to the blades by pitch control rods, and also a non-rotary swashplate, the rotary swashplate being movable in rotation about an axis of rotation of the rotor, a lower scissors linkage being hinged to the non-rotary swashplate and being hinged to a member that is stationary in rotation about the axis of rotation in the reference frame of the aircraft, the rotor comprising a plurality of servo-controls, each servo-control being provided with a “top” hinge hinged to a top attachment fitting of the non-rotary swashplate and with a “bottom” hinge hinged to a bottom attachment fitting that is stationary in the reference frame of the aircraft.

A bearing device may be interposed between the rotary swashplate and the non-rotary swashplate to promote rotation of the rotary swashplate about the axis of rotation of the rotor relative to the non-rotary swashplate.

Under such circumstances, for at least one the servo-control referred to as the “inclined servo-control”, the bottom hinge is offset in azimuth about the axis of rotation relative to the top hinge of the inclined servo-control.

At least one servo-control is therefore a servo-control that is inclined, and that is named “inclined servo-control”. It is possible that several, or even all, of the servo-controls are inclined.

The expression “offset in azimuth” means that the top hinge and the bottom hinge do not present the same azimuth angle relative to a reference plane containing the axis of rotation of the rotor. An inclined servo-control thus does not extend from the bottom hinge to the top hinge in a plane of symmetry containing the axis of rotation of the rotor.

The top hinge allows movement between the servo-control and the non-rotary swashplate about a center referred to as the “top hinge center” for convenience. For this purpose the top hinge may take the form of a ball-joint.

In addition, the bottom hinge allows movement between the servo-control and the stationary member about a center referred to as the “bottom hinge center” for convenience. For this purpose, the bottom hinge may take the form of a ball-joint.

Consequently, given the offset in azimuth, the bottom hinge center and the top hinge center are respectively contained in two separate planes in elevation each containing the axis of rotation of the rotor.

Conversely, prior art rotors present servo-controls that are not offset in azimuth.

On at least one servo-control referred to as the “inclined servo-control”, the invention thus introduces a small angular offset in azimuth between the bottom hinge and the top hinge of this inclined servo-control. The offset in azimuth may tend to generate additional torque on the lower scissors linkage, which always imposes the same sign to the torque generated by the servo-controls on the lower scissors linkage. Consequently, the non-rotary swashplate does not generate impacts in the lower scissors linkage.

This aircraft thus presents the advantage of tending to reduce significantly the stresses exerted on the lower scissors linkage, and thus to limit wear of the lower scissors linkage. Consequently, the lower scissors linkage may possibly be optimized in such a manner as to present a smaller weight and to generate reduced manufacturing and/or maintenance costs.

By way of illustration, a tangential offset of a few millimeters of one of the top and bottom hinges of an inclined servo-control, relative to a position that is non-offset in azimuth, leads to an offset in azimuth of a few degrees between the top and bottom hinges. By way of example, a tangential offset lying in the range 10 millimeters (mm) to 20 mm for a servo-control having a length of the order of 800 mm may lead to an offset in azimuth of 1 to 2 degrees.

This angular offset in azimuth may be optimized by simulation and/or testing. By way of example, the required offset in azimuth may be evaluated so as to be sufficient so as to ensure that the second torque induced by the servo-controls is always of the same sign in the most critical stages of flight. In addition, the required offset in azimuth may be limited so as not to increase more than is necessary the torque induced by the servo-controls and in order to optimize the angular clearance of the ball joints of the servo-controls.

Furthermore, the aircraft may include one or more of the following characteristics.

For at least one the inclined servo-control, a bottom hinge center of the bottom hinge of the inclined servo-control may be offset in azimuth relative to a top hinge center of the top hinge of the inclined servo-control.

By way of example, at least one of the bottom and top hinges is a ball-joint. Such a ball-joint procures a freedom of movement in rotation along three axes coinciding at a hinge center of the ball-joint.

For at least one the inclined servo-control, a reference plane containing the axis of rotation of the rotor and a bottom hinge center of the bottom hinge, a top plane being orthogonal to the axis of rotation and containing a top hinge center of the top hinge of the inclined servo-control, an angle referred to as the non-zero “top angle” may separate the top hinge center of the top hinge and the reference plane circumferentially and about the axis of rotation in the top plane.

The bottom hinge presents an angle of azimuth that is zero relative to the reference plane. However, the top hinge presents an angle of non-zero azimuth relative to the reference plane, the angle being referred to for convenience as the “top angle”.

Optionally, the rotor performing rotary movement in one given direction of rotation about the axis of rotation, the top hinge center moves away from the reference plane in the direction of rotation.

The offset in azimuth of the hinges of an inclined servo-control is performed in preferred manner according to this variant in the direction of rotation of the rotor, in order to create torque that is added to the torque generated by the friction forces of the bearing.

However, an offset in azimuth in a direction opposite to the direction of rotation may be envisaged.

Optionally, the rotor comprises at least three servo-controls, the three servo-controls comprising: a left side servo-control tending to tilt the set of swashplates towards a left flank of the aircraft; a right side servo-control tending to tilt the set of swashplates towards a right flank of the aircraft; and a front servo-control tending to tilt the set of swashplates towards a front end of the aircraft; and at least the front servo-control is an inclined servo-control, each servo-control that is not an inclined servo-control having a bottom hinge that is not offset in azimuth relative to a top hinge of the servo-control.

The left side servo-control, the right side servo-control, and the front servo-control are common practice on a rotorcraft rotor, and in particular on a main rotor of a helicopter. Optionally, the rotor may also comprise a servo-control referred to as the “rear servo-control” tending to tilt the set of swashplates towards a rear end of the aircraft.

Advantageously, at least the servo-control that controls tilting of the set of swashplates in forward flight and referred to as the “front servo-control” is an inclined servo-control.

In another aspect, at least the bottom attachment fitting or the top attachment fitting of an inclined servo-control comprises a clevis, the clevis presenting at least one plane plate through which a pin passes, the plane plate is parallel to a straight line containing the bottom hinge center and the top hinge center of the inclined servo-control.

If necessary, some clevises may be inclined to accommodate angular movement of the ball-joints of the servo-controls without interference.

In addition to an aircraft, the invention provides a method of optimizing an aircraft having a rotary wing provided with a rotor, the rotor being provided with blades and a set of swashplates, the set of swashplates comprising both a rotary swashplate connected to the blades by pitch control rods, and also a non-rotary swashplate, the rotary swashplate being movable in rotation about an axis of rotation of the rotor, a lower scissors linkage being hinged to the non-rotary swashplate and being hinged to a member that is stationary in rotation about the axis of rotation in a reference frame of the aircraft, the rotor comprising a plurality of servo-controls, each servo-control being provided with a “top” hinge hinged to a top attachment fitting of the non-rotary swashplate and with a “bottom” hinge hinged to a bottom attachment fitting that is stationary in a reference frame of the aircraft.

For at least one the servo-control referred to as the “inclined servo-control”, the method comprises a step of:

offsetting in azimuth the top hinge about the axis of rotation relative to the bottom hinge.

Optionally, the rotor performs rotary movement in one given direction of rotation about the axis of rotation, the rotor possesses a servo-control positioned before implementation of the method in a virtual mid-position in which the bottom hinge is not offset in azimuth about the axis of rotation relative to the top hinge, and the step of offsetting in azimuth includes a sub-step of offsetting the top hinge in azimuth relative to the mid-position in the direction of rotation.

Optionally, the rotor performs rotary movement in one given direction of rotation about the axis of rotation, the rotor possesses a servo-control positioned before implementation of the method in a virtual mid-position in which the bottom hinge is not offset in azimuth about the axis of rotation relative to the top hinge, and the step of offsetting in azimuth includes a sub-step of offsetting the bottom hinge in azimuth relative to the mid-position in a direction opposite to the direction of rotation.

The method may be applied to an existing aircraft. Under such circumstances, the top hinge of an inclined servo-control and the top attachment fitting associated therewith may be offset in the direction of rotation of the rotor, and/or the bottom hinge of an inclined servo-control and the bottom attachment fitting associated therewith may be offset in the direction opposite to the direction of rotation of the rotor.

A plurality of attachment fittings and hinges, possibly from a plurality of servo-controls, may be offset so as to reduce the angular offset that would have been necessary if only one attachment fitting were offset. This characteristic makes it possible to limit the inclination of the inclined servo-controls so as to optimize clearance.

### BRIEF DESCRIPTION OF THE DRAWINGS

The invention and its advantages appear in greater detail in the context of the description below with examples given by way of illustration and with reference to the accompanying figures, in which:

FIG. 1 is a diagrammatic view of an aircraft of the invention;

FIG. 2 is a three-dimensional view of a rotor of the invention;

FIG. 3 is a diagram showing the azimuth offsets of bottom and top hinges of an inclined servo-control; and

FIGS. 4 to 7 show the advantage of the invention, FIGS. 4 and 5 show respectively the torque induced by the servo-controls on a lower scissors linkage and the forces exerted on the lower scissors linkage in a rotor provided with non-inclined servo-controls, FIGS. 6 and 7 show respectively the torque induced by the servo-controls on a lower scissors linkage and the forces exerted on the lower scissors linkage in a rotor provided with at least one servo-control that is inclined.

Elements present in more than one of the figures are given the same references in each of them.

### DETAILED DESCRIPTION OF THE INVENTION

It should be observed that three mutually orthogonal directions X, Y, and Z are shown in some of the figures.

The first direction X is the to be longitudinal. The term “longitudinal” relates to any direction parallel to the first direction X.

The second direction Y is the to be transverse. The term “transverse” relates to any direction parallel to the second direction Y.

Finally, the third direction Z is the to be in elevation. The term “in elevation” relates to any direction parallel to the third direction Z.

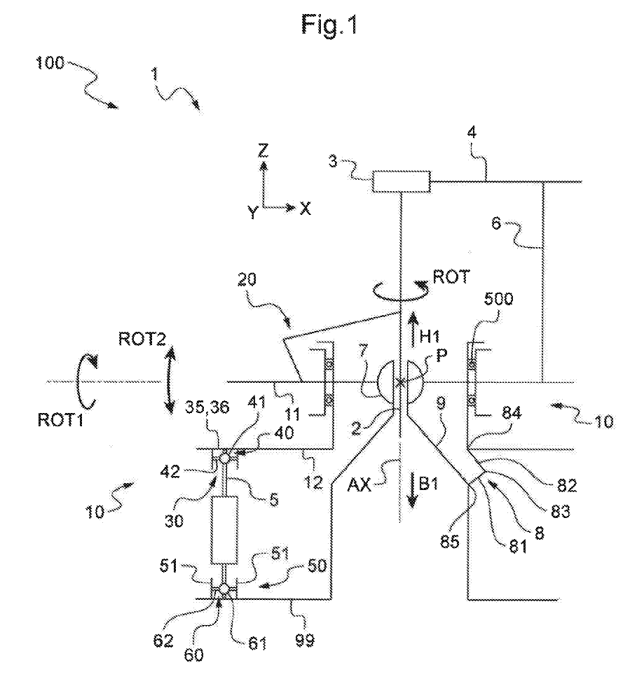

FIG. 1 is a diagrammatic view of an aircraft 100 of the invention. This aircraft 100 is provided with a rotor 1. By way of example, the rotor 1 is a rotor of a rotary wing and contributes at least in part to providing the aircraft 100 with propulsion and/or lift. The other members of the aircraft are not shown in order to avoid overloading FIG. 1.

The aircraft 100 may therefore be a rotorcraft, and in particular a helicopter for example.

The rotor 1 is provided with a rotor mast 2 extending in elevation along an axis of rotation AX. A power plant drives the rotor mast in rotation about the axis of rotation AX.

The rotor mast 2 is constrained to rotate about the axis of rotation AX with a plurality of blades 4. By way of example, the rotor mast 2 is fastened to a hub 3. The hub 3 carries and drives in rotation a plurality of blades 4.

The rotor 1 is further provided with a set of swashplates 10 that is connected to flight controls by servo-controls 5.

More precisely, the set of swashplates 10 comprises a first swashplate referred to as the “non-rotary swashplate 12” arranged on a mast ball-joint 7. The mast ball-joint 7 is slidably arranged on a stationary element 9 of the structure of the aircraft. In addition, the non-rotary swashplate 12 is connected by a lower scissors linkage 8 to a stationary member 99 in the reference frame of the aircraft. By way of example, such a member 99 may be a casing element of a main gearbox. In addition, the stationary member 99 may coincide with the stationary element 9.

The lower scissors linkage 8 has the function of preventing any rotation of the non-rotary swashplate 12 about the axis of rotation AX, ignoring manufacturing clearances of the lower scissors linkage 8.

The lower scissors linkage 8 may comprise a top branch 82, e.g. delta (Δ)-shaped, which is hinged to the non-rotary swashplate 12 via a ball-joint 84.

In addition, the lower scissors linkage 8 may comprise a bottom branch 81, e.g. H-shaped. This bottom branch 81 is hinged to the member 99 via a bottom hinge 85. This bottom hinge 85 comprises a pivot hinged about an axis to a clevis of the bottom branch and to a lug of the member 99. This bottom hinge 85 presents an axial clearance that may be as much as one millimeter, by way of example.

In addition, the bottom branch 81 is hinged to the top branch 82 via a central hinge 83. This central hinge 83 presents a pivot hinged about an axis to a clevis of the bottom branch 81 and a lug of the top branch 82. This central hinge 83 presents axial clearance that may be as much as one millimeter, by way of example.

Furthermore, the set of swashplates 10 includes a second swashplate referred to as the “rotary swashplate 11” that co-operates with the non-rotary swashplate 12 via a fastener system 500. By way of example, the rotary swashplate 11 carries the non-rotary swashplate 12 via the fastener system 500. The fastener system 500 allows the rotary swashplate 11 to perform only rotary movement about the axis of rotation AX, relative to the non-rotary swashplate 12. By way of example, such a fastener system 500 may comprise a ball or roller bearing system.

In addition, the set of swashplates 10 possesses drive means 20 connecting the rotary swashplate 11 to rotate with the rotor mast 2, such as a top two-branch scissors linkage, for example. The drive means 20 leads to the swashplate being driven by the rotor mast 2 about the axis of rotation AX.

By way of example, the rotary swashplate 11 and the non-rotary swashplate 12 are concentric. The non-rotary swashplate 12 is optionally arranged within a circular housing of the rotary swashplate.

Reference may be made to the literature to obtain more information about the arrangement and operation of the non-rotary swashplate 12 and of the rotary swashplate 11 of a set of swashplates 10. Reference may also be made to document FR 2 848 524 that describes a connection between the rotary swashplate and the non-rotary swashplate.

Under such circumstances, the non-rotary swashplate 12 is connected to the flight commands by servo-controls 5, while the rotary swashplate 11 is connected to each blade by a pitch control rod 6.

When the pitch controls require a collective increase of pitch of the blades 4, the servo-controls extend in identical manner so as to move the non-rotary swashplate 12 and the rotary swashplate 11 jointly in translation along the axis of rotation AX along arrow H1. When the pitch controls require a collective reduction of pitch of the blades 4, the servo-controls retract in identical manner so as to move the non-rotary swashplate 12 and the rotary swashplate 11 jointly in translation along the axis of rotation AX along arrow B1.

However, if the pitch controls require cyclic variation of pitch of the blades 4, at least one servo-control 5 extends or retracts in a manner that is different from the other servo-controls. The non-rotary swashplate 12 and the rotary swashplate 11 thus tilt jointly relative to a point P corresponding to the center of the mast ball-joint 7. In particular, the non-rotary swashplate 12 and the rotary swashplate 11 may perform two movements in rotation ROT1, ROT2 about two axes that are mutually orthogonal.

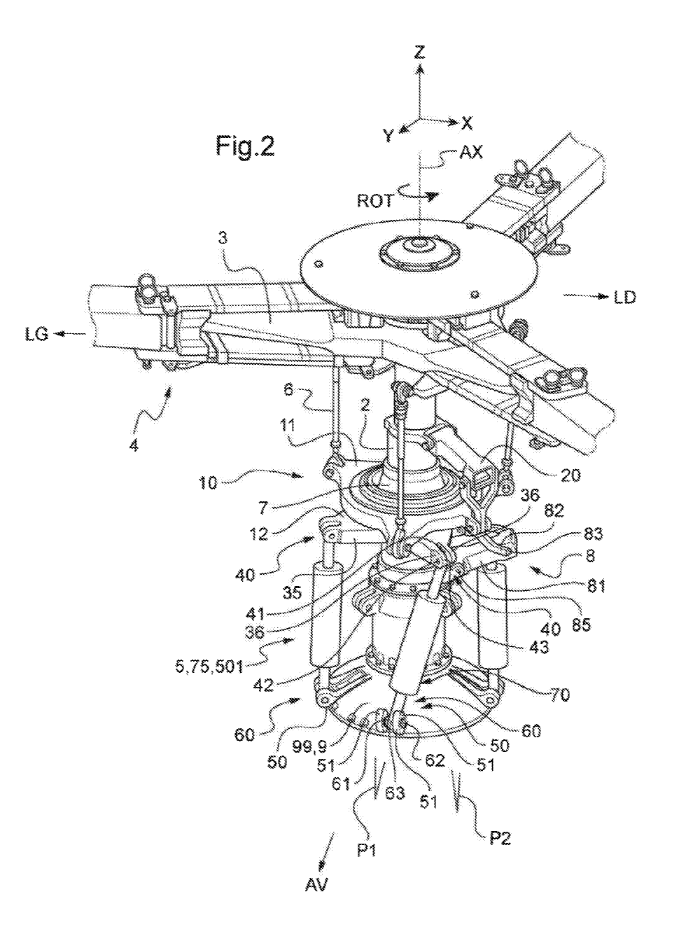

With reference to FIG. 2, each servo-control 5 is provided with a top hinge 40 that is hinged to a top attachment fitting 35 of the non-rotary swashplate 12. The top hinge 40 may comprise a ball-joint 41 that is arranged in a cage fastened to the servo-control. In addition, the top hinge 40 may include a pin 42 that passes through the ball-joint 41 and at least one plate 36 of a clevis of the top attachment fitting 35.

Each servo-control 5 thus presents degrees of freedom to move in rotation relative to a top hinge center 43 of the top hinge 40.

In addition, each servo-control 5 is provided with a bottom hinge 60 that is hinged to a bottom attachment fitting 50 that is stationary in a reference frame of the aircraft 100. By way of example, such a bottom attachment fitting 50 may be fastened to the member 99. The bottom hinge 60 may comprise a ball-joint 61 that is arranged in a cage fastened to the servo-control. In addition, the bottom hinge 60 may include a pin 62 that passes through the ball-joint 61 and at least one plate 51 of a clevis of the bottom attachment fitting 60.

Each servo-control 5 thus presents degrees of freedom to move in rotation relative to a bottom hinge center 63 of the bottom hinge 60.

In another aspect, at least one servo-control 5 is a servo-control referred to as “inclined servo-control 70”. An inclined servo-control 70 comprises a bottom hinge 60 that is offset in azimuth about the axis of rotation AX relative to the top hinge 40 of the inclined servo-control 70.

By way of example, the bottom hinge center 63 of the bottom hinge 60 is offset in azimuth relative to a top hinge center 43 of the top hinge 40.

Under such circumstances, the bottom hinge center 63 is located in a first plane in elevation P1 containing the axis of rotation AX. However, the top hinge center 43 is located in a second plane in elevation P2 containing the axis of rotation AX, the second plane in elevation P2 being distinct from the first plane P1.

In particular, the rotor 1 may comprise at least three servo-controls 5 including:

a left side servo-control 501 designed in particular to tilt the set of swashplates 10 towards a left flank LG of the aircraft 100;

a right side servo-control that is hidden in FIG. 2 designed in particular to tilt the set of swashplates 10 towards a right flank LD of the aircraft 100; and

a front servo-control 502 designed in particular to tilt the set of swashplates 10 towards a front end AV of the aircraft 100.

Optionally, a rear servo-control may be designed in particular to tilt the set of swashplates 10 towards a rear end of the aircraft 100.

Under such circumstances, at least the front servo-control 502 may optionally be an inclined servo-control 70.

All of the servo-controls 5 may be inclined servo-controls.

However, at least one servo-control 5 may be a servo-control referred to as “non-inclined servo-control 75”. Such a non-inclined servo-control 75 presents a bottom hinge that is not offset in azimuth relative to a top hinge of the servo-control.

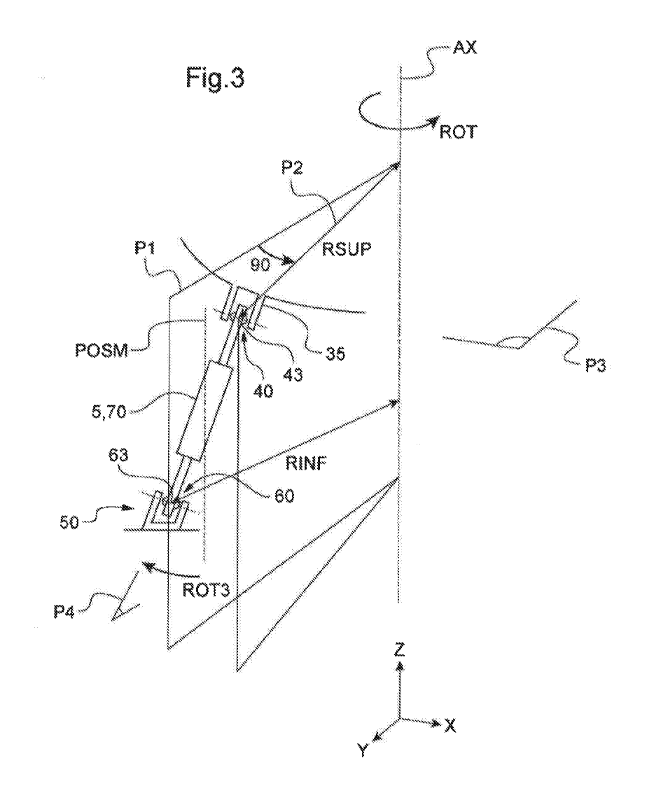

With reference to FIG. 3, for an inclined servo-control 70, the bottom hinge center 63 of the bottom hinge 60 may be located in a reference plane P1 containing the axis of rotation AX.

The top hinge center 43 of the top hinge 40 is in addition located in a top plane P3 that is orthogonal to the axis of rotation AX.

Under such circumstances, the top hinge center 40 is circumferentially offset in the top plane P3 from the reference plane P1 by a non-zero top angle 90 about the axis of rotation AX.

Optionally, the rotor 1 performing rotary movement in one direction of rotation ROT about the axis of rotation AX, the top hinge center 43 may move away from the reference plane P1 in the direction of rotation ROT.

In another aspect, the bottom attachment fitting 50 and/or the top attachment fitting 35 of an inclined servo-control 70 comprises a clevis co-operating with the top hinge or the bottom hinge. The clevis presents at least one plane plate 36, 51 through which a pin 42, 62 of the hinge under consideration passes. Optionally, this plate 36, 51 is parallel to a straight line P4 passing through the bottom hinge center 63 and the top hinge center 43.

Under such circumstances, the method of the invention provides a step of offsetting the top hinge 40 in azimuth about the axis of rotation AX relative to the bottom hinge 60 for an inclined servo-control 70.

Optionally, the rotor 1 may possess a servo-control positioned prior to implementation of the method in a mid-position POSM in which the bottom hinge is not offset in azimuth about the axis of rotation relative to the top hinge. Under such circumstances, the step of offsetting the hinge in azimuth may comprise a sub-step of offsetting the top hinge 40 in azimuth in the direction of rotation ROT relative to the mid-position POSM, and/or a sub-step of offsetting the bottom hinge 60 in azimuth in a direction ROT3 opposite the direction of rotation ROT relative to the mid-position POSM.

In addition, all of the servo-controls have a bottom hinge center 63 that is spaced apart radially from the axis of rotation AX by a bottom radius RINF, and a top hinge center 43 that is spaced apart radially from the axis of rotation AX by a top radius RSUP. FIG. 3 shows a servo-control having a bottom radius RINF that is equal to the top radius RSUP. Nevertheless, whether the servo-control is an inclined or a non-inclined servo-control, the bottom radius RINF and the top radius RSUP of the servo-control may be different. In particular, the top radius RSUP may be greater than the bottom radius RINF.

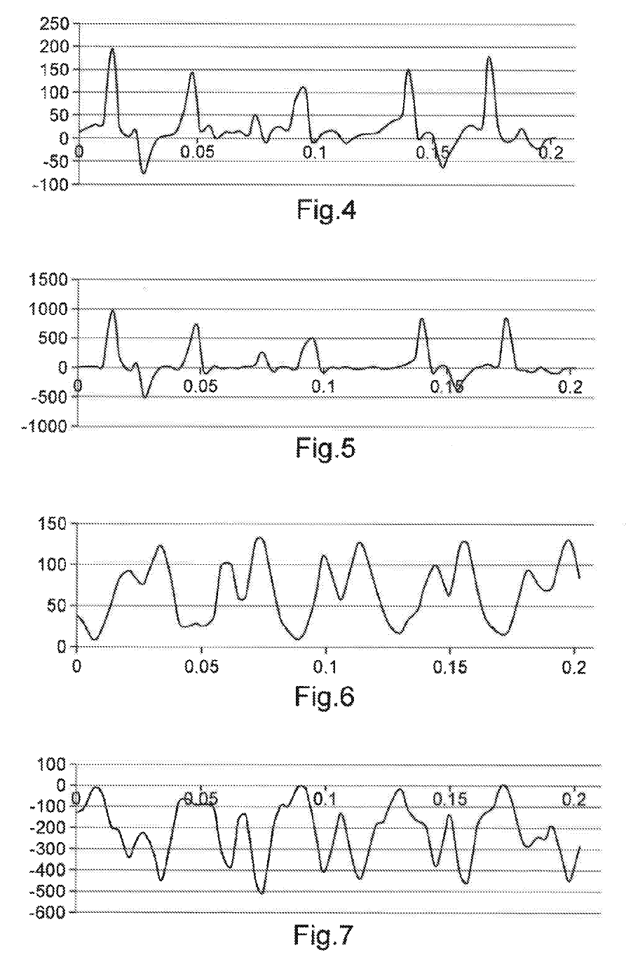

FIGS. 4 to 7 show the advantageous results of the invention.

FIGS. 4 and 5 show respectively, for one revolution of the rotor, the torque induced by the servo-controls on a lower scissors linkage and the forces exerted on the lower scissors linkage in a rotor provided with non-inclined servo-controls.

In particular, FIG. 4 shows the torque induced on the lower scissors linkage by the servo-controls, on an aircraft that does not have inclined servo-controls. FIG. 4 is in the form of a graph plotting the torque up the ordinate axis as a function of time plotted along the abscissa axis.

The torque induced by the servo-controls varies from 200 Nm to −50 Nm with a change in sign, which leads to shocks in the lower scissors linkage.

Under such circumstances, FIG. 5 shows the forces to which the lower scissors linkage is subjected, on an aircraft that does not have inclined servo-controls. FIG. 5 is in the form of a graph plotting the forces up the ordinate axis as a function of time plotted along the abscissa axis.

The forces to which it is subjected vary considerably, lying in the range −500 newtons (N) to 1000 N, i.e. forces of the order of 250 N±750 N.

FIGS. 6 and 7 show respectively, for one revolution of the rotor, the torque induced by the servo-controls on a lower scissors linkage and the forces exerted on the lower scissors linkage in a rotor provided with at least one servo-control that is inclined.

FIG. 6 shows in particular the torque induced on the lower scissors linkage by the servo-controls, on an aircraft of the invention. FIG. 6 is in the form of a graph plotting the torque up the ordinate axis as a function of time plotted along the abscissa axis.

Under such circumstances, the torque induced by the servo-controls varies from 5 Nm to 120 Nm without a change in sign, which does not lead to shocks in the lower scissors linkage. In addition, the range of torque variation is much smaller than the range of variation without the invention, as shown in FIG. 4.

Under such circumstances, FIG. 7 shows the forces to which the lower scissors linkage is subjected, on an aircraft of the invention. FIG. 7 is in the form of a graph plotting the forces up the ordinate axis as a function of time plotted along the abscissa axis.

The forces to which it is subjected vary over a limited range, lying in the range −500 N to −10 N, i.e. forces of the order of 245 N±255 N. The lower scissors linkage is thus subjected to dynamic forces that are substantially equal to one third of the dynamic forces to which it would be subjected without the invention.

Naturally, the present invention may be subjected to numerous variations as to its implementation. Although several embodiments are described, it should readily be understood that it is not conceivable to identify exhaustively all possible embodiments. It is naturally possible to envisage replacing any of the means described by equivalent means without going beyond the ambit of the present invention.

What is claimed is:

1. An aircraft comprising a rotor, the rotor being provided with blades and a set of swashplates, the set of swashplates comprising both a rotary swashplate connected to the blades by pitch control rods, and also a non-rotary swashplate, the rotary swashplate being movable in rotation about an axis of rotation of the rotor, a lower scissors linkage being hinged to the non-rotary swashplate and being hinged to a member that is stationary in rotation about the axis of rotation, the rotor comprising a plurality of servo-controls, each servo-control being provided with a top hinge hinged to a top attachment fitting of the non-rotary swashplate and with a bottom hinge hinged to a bottom attachment fitting that is stationary in a reference frame of the aircraft, wherein for at least one the servo-control referred to as an “inclined servo-control”, the bottom hinge is offset in azimuth about the axis of rotation relative to the top hinge.

2. The aircraft according to claim 1, wherein for at least one the inclined servo-control, a bottom hinge center of the bottom hinge is offset in azimuth relative to a top hinge center of the top hinge.

3. The aircraft according to claim 2, wherein for the at least one the inclined servo-control, a reference plane containing the axis of rotation and the bottom hinge center of the bottom hinge, a top plane being orthogonal to the axis of rotation and containing the top hinge center of the top hinge, a non-zero top angle separates the top hinge center and the reference plane circumferentially and about the axis of rotation in the top plane.

4. The aircraft according to claim 3, wherein, the rotor performing rotary movement in one direction of rotation about the axis of rotation, the top hinge center moves away from the reference plane in the direction of rotation.

5. The aircraft according to claim 1, wherein the rotor comprising at least three servo-controls, the three servo-controls comprising: a left side servo-control tending to tilt the set of swashplates towards a left flank of the aircraft; a right side servo-control tending to tilt the set of swashplates towards a right flank of the aircraft; and a front servo-control tending to tilt the set of swashplates towards a front end of the aircraft; and at least the front servo-control is a the inclined servo-control, each servo-control that is not an inclined servo-control having a bottom hinge that is not offset in azimuth relative to a top hinge of the servo-control.

6. The aircraft according to claim 3, wherein at least a the bottom attachment fitting or the top attachment fitting of a the inclined servo-control comprises a clevis, the clevis presenting at least one plane plate through which a pin passes, the plane plate is parallel to a straight line containing the bottom hinge center and the top hinge center.

7. A method of optimizing an aircraft having a rotary wing provided with a rotor, the rotor being provided with blades and a set of swashplates, the set of swashplates comprising both a rotary swashplate connected to the blades by pitch control rods, and also a non-rotary swashplate, the rotary swashplate being movable in rotation about an axis of rotation of the rotor, a lower scissors linkage being hinged to the non-rotary swashplate and being hinged to a member that is stationary in rotation about the axis of rotation, the rotor comprising a plurality of servo-controls, each servo-control being provided with a top hinge hinged to a top attachment fitting of the non-rotary swashplate and with a bottom hinge hinged to a bottom attachment fitting that is stationary in a reference frame of the aircraft;
wherein for at least one the servo-control referred to as an “inclined servo-control”, the method comprises a step of:
offsetting in azimuth the top hinge about the axis of rotation relative to the bottom hinge.

8. An aircraft according to claim 7, wherein, the rotor performs rotary movement in one direction of rotation about the axis of rotation, the rotor possesses a servo-control positioned before implementation of the method in a mid-position in which the bottom hinge is not offset in azimuth about the axis of rotation relative to the top hinge, and the step of offsetting in azimuth includes a sub-step of offsetting the top hinge in azimuth relative to the mid-position in the direction of rotation.

9. An aircraft according to claim 7, wherein, the rotor performs rotary movement in one direction of rotation about the axis of rotation, the rotor possesses a servo-control positioned before implementation of the method in a mid-position in which the bottom hinge is not offset in azimuth about the axis of rotation relative to the top hinge, and the step of offsetting in azimuth includes a sub-step of offsetting the bottom hinge in azimuth relative to the mid-position in a direction opposite to the direction of rotation.
